(19) United States
(12) Patent Application Publication
(10) Pub. No.: US 2011/0173412 A1
(43) Pub. Date: Jul. 14, 2011

(54) DATA PROCESSING DEVICE AND MEMORY PROTECTION METHOD OF SAME

(75) Inventors: Ryo TABEI, Kawasaki (JP); Hiroshi KONDO, Kawasaki (JP); Hiroyuki IZUI, Kawasaki (JP); Keizo AZUMA, Kawasaki (JP)

(73) Assignee: FUJITSU LIMITED, Kawasaki (JP)

(21) Appl. No.: 13/069,083

(22) Filed: Mar. 22, 2011

Related U.S. Application Data
(63) Continuation of application No. PCT/JP2008/067100, filed on Sep. 22, 2008.

(51) Int. Cl. G06F 12/00

(52) U.S. Cl. 711/213; 711/E12.001

(57) ABSTRACT

A memory protection method includes setting a memory area in at least one address setting register; setting a trap type in a trap type setting register corresponding to the address setting register; generating a trap of the trap type set in the trap type setting register in accordance with an access request to the memory area set at the address setting register; setting a size of an inaccessible area in a memory; allocating, in accordance with a memory allocation request from an application, a memory area to the application as an accessible area and an inaccessible area having the inaccessible area size right after the accessible area; setting the inaccessible area in a first address setting register and a first trap type in a first trap type setting register; and generating a memory image of the application and closing the application when a trap of the first trap type occurred.

### CROSS-REFERENCE TO RELATED APPLICATION

This application is a continuation application based upon International Application No. PCT/JP2008/67100, filed on Sep. 22, 2008, the entire contents of which are incorporated herein by reference.

### FIELD

The present invention relates to a data processing device and a memory protection method which prevents memory destruction by an improper write operation in a data processing device.

### BACKGROUND

An application or a process operating on an operating system (OS) of a data processing device acquires a memory area from the OS by a dynamic allocation request of memory. However, the application may sometimes perform an invalid write operation on an area other than the acquired memory area. In this case, the memory area which is used for another application is destroyed, so that the application may malfunction or end abnormally or other trouble may occur.

In particular, there are many cases where the application performs a write operation which exceeds the acquired memory area and thereby destroys the next area. For example, as shown in FIG. 1, there is the case where, despite only an 8-byte area being acquired, 9 bytes' worth of data are written, so 1 byte of the area after the acquired area is destroyed.

In this way, sometimes a certain process will destroy the memory area due to an invalid write operation, then the process may malfunction or end abnormally by referring to that destroyed area. In this case, since the timings of the process which performed the invalid write operation and the process which detects memory destruction differ, it becomes difficult to identify the cause. In particular, when the time from the point of time when the invalid write operation was performed to the point of time when the destroyed area is referred to is long, identification of the cause of the memory destruction will become further difficult.

As a memory protection method for preventing memory destruction by an invalid write operation, the related art illustrated in FIG. 2 is known. This related art includes a main storage device comprised of a memory 200, an application 210 which uses the memory 200, and an OS 220 which allocates memory in accordance with a dynamic memory allocation request from the application 210.

The application 210 issues a memory allocation request to the OS 220 to acquire a data area for itself (block 212). The OS 220 acquires a memory area 202 for the memory allocation request from the application 210 and sets a no-access attribute for a memory area 204 continuing after that memory area (blocks 222 and 224).

Specifically, in this system, the memory is managed in units of a specific size of memory blocks. When a memory allocation request is issued from the application 210, the OS 220 sets a no-access attribute at the one memory block 204. Further, the OS 220 acquires a memory area 202, of the size requested by the application, which starts from the end of the memory block right before the memory block 204 and proceeds forward.

Further, the OS 220 allocates the memory area 202 to the application 210 (block 226). When the application 210 is allocated the memory area 202, it can perform a write operation on the memory area 202. However, the application 210 may sometimes issue an access request exceeding the memory area 202 to the area 204 at which the no-access attribute is set (block 214). In this case, an exception trap/interrupt will occur. The OS 220 will execute access exception processing to prevent an invalid write operation on the memory area 204 (block 228).

FIG. 3 is a view for explaining the issues in the related art illustrated in FIG. 2. In this related art, at the time of a memory allocation request from the application, it is necessary to acquire an extra memory block at which a no-access attribute is set. This memory block, even at the smallest, is of a memory management unit of the OS (one page, for example, 1 page=8 kB), so the memory resources will be greatly wasted.

Further, the address of the allocated memory has to match a page boundary. However, with the technique, like in the above related art, of allocating a memory area of the requested size starting from the end of a memory block and proceeding forward, the address of the allocated memory may not match with a page boundary. If accessing such an address, error will occur, so it is necessary to acquire extra memory to adjust the alignment. See Japanese Laid-Open Patent Publication No. 2002-055851.

### SUMMARY

According to the present disclosed art, there is provided a data processing device including at least one address setting register that sets a memory area; a trap type setting register that sets a trap type and corresponds to the address setting register; a trap generating unit that generates a trap of the trap type set in the trap type setting register in accordance with an access request to the memory area set at the address setting register; an inaccessible area size setting unit that sets an inaccessible area size; a memory allocating unit that allocates, in accordance with a memory allocation request from an application, a memory area to the application as an accessible area and an inaccessible area having the inaccessible area size right after the accessible area, and sets the inaccessible area in a first address setting register and a first trap type in a first trap type setting register; and a memory access processing unit that generates a memory image of the application and closing the application when a trap of the first trap type is received from the trap generating unit.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

All examples and conditional language recited hereinafter are intended for pedagogical purposes to aid the reader in understanding the principles of the invention and the concepts contributed by the inventors to furthering the art and are to be construed as being without limitation to such specifically recited examples and conditions, nor does the organization of such examples in the specification relate to a showing of the superiority and inferiority of the invention. In the attached drawings:

FIG. 1 is a view for explaining memory destruction due to an invalid write operation;

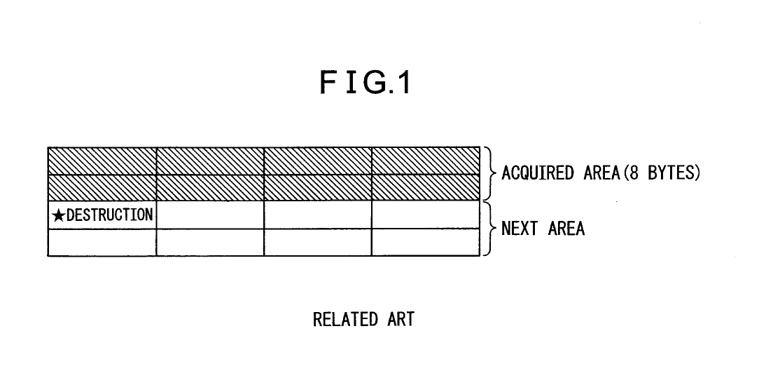

FIG. 2 is a view for explaining a related example of a memory protection method which prevents memory destruction due to an invalid write operation;

FIG. 3 is a view for explaining issues in the related art illustrated in FIG. 2;

FIG. 4 is a view illustrating a hardware configuration of a data processing device according to the present disclosed art;

FIG. 5 is a flowchart illustrating the processing at the time of memory allocation;

FIG. 6 is a flowchart illustrating the processing at the time of memory access;

FIG. 7 is a view illustrating the setting of memory areas;

FIG. 8 is a view for explaining an operation corresponding to the setting of the memory areas illustrated in FIG. 7; and

FIG. 9 is a view for explaining memory acquisition processing according to the present disclosed art.

### DESCRIPTION OF EMBODIMENTS

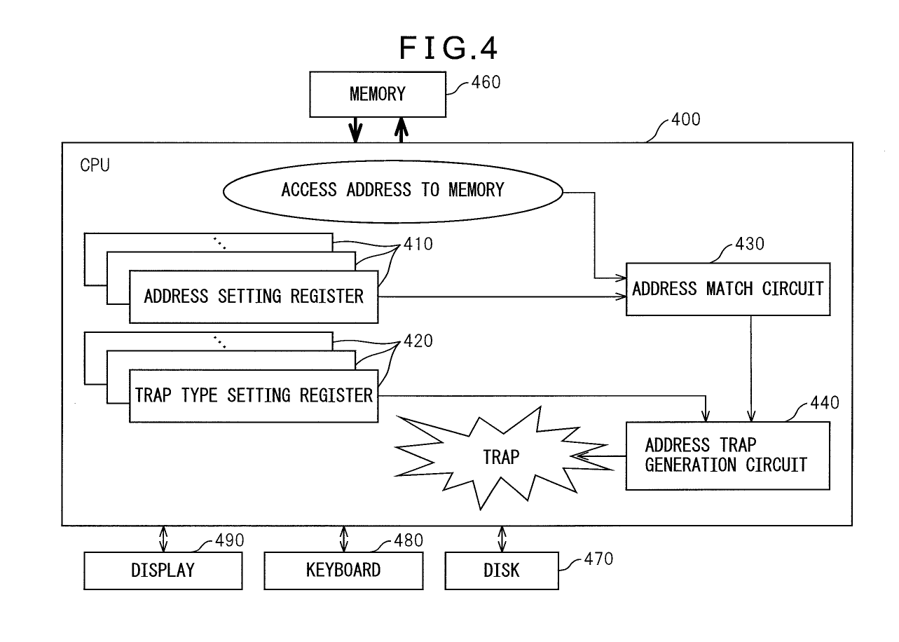

Below, an embodiment of the disclosed art will be explained with reference to the attached drawings. FIG. 4 is a view illustrating a hardware configuration of a data processing device according to the present disclosed art. This data processing device includes a CPU (central processing unit) 400, memory 460, magnetic disk device 470, keyboard 480, and display 490. The CPU 400 runs an OS and application which are loaded in a main storage device comprised of the memory 460. Further, the CPU 400 is provided with a plurality of address setting registers 410, a plurality of trap type setting registers 420, an address match circuit 430, and an address trap generation circuit 440.

Each of the plurality of address setting registers 410 is set with an address for designating a memory area. The plurality of trap type setting registers 420 are provided corresponding to the plurality of address setting registers 410. Each is set with a trap type. A “trap type” is information showing the type of a trap causing occurrence of an exception etc. The address match circuit 430 and address trap generation circuit 440 are trap mechanisms for generating a trap of a trap type set in a corresponding trap type setting register 420 in accordance with an access request to a memory area set in each address setting register 410.

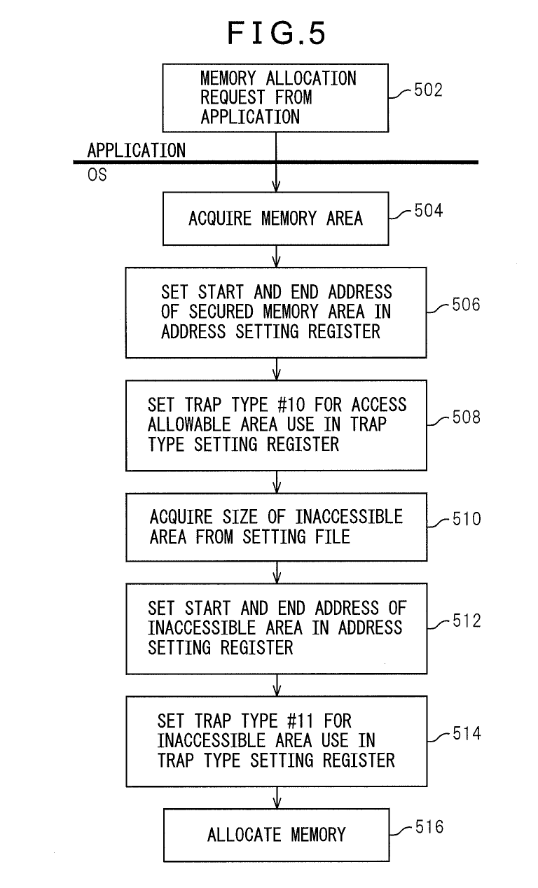

FIG. 5 is a flowchart illustrating the processing at the time of memory allocation. It is assumed that a user has used a method described in a setting file etc. to preset the size of an inaccessible area to be set right after a memory area which has been allocated to an application.

First, the application issues a memory allocation request to the OS (block 502). Receiving the request, the OS acquires a memory area having the requested memory size as an accessible area (block 504). Next, the OS sets a start address and an end address of the acquired memory area, i.e. accessible area in one of the address setting registers 410 (block 506).

Further, the OS sets, for the acquired memory area, for example “#10”, as a trap type expressing that the accessible area has been accessed by a normal access request, in the corresponding trap type setting register 420 (block 508). This trap type is determined so as not to overlap other trap types which have been already set in the data processing device.

Next, the OS acquires the inaccessible area size which the user set in advance in the setting file (block 510). Further, the OS sets an inaccessible area which has the acquired inaccessible area size right after the memory area which was allocated to the application and sets the start address and the end address of the inaccessible area in another of the address setting registers 410 (block 512).

Further, the OS sets, for the inaccessible area, for example “#11”, as a trap type for inaccessible area use expressing that the area has been accessed by an improper access request, in the corresponding trap type setting register 420 (block 514). This trap type is determined so as not to overlap other trap types which have been already set in the data processing device. Finally, the OS allocates the acquired memory area (accessible area) to the application originating the request (block 516). This ends the memory allocation processing.

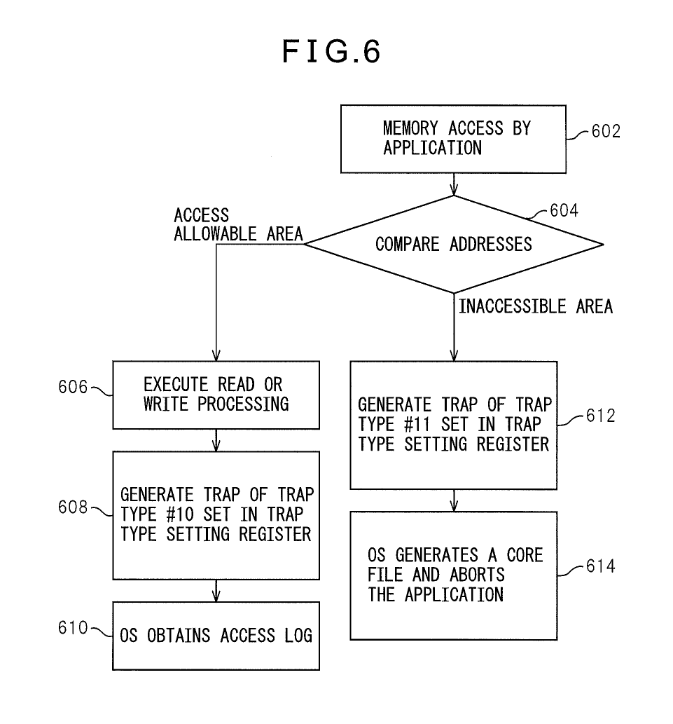

FIG. 6 is a flowchart illustrating the processing at the time of memory access. First, the application issues an instruction accompanied with a memory access, that is, a memory access request (block 602). The address match circuit 430 compares the access address of that memory access request with the start address and end address set in each address setting register 410 so as to determine if the access address is an address in an accessible area of if the access address is an address in an inaccessible area (block 604).

If the access address is an address in an accessible area, the read or write processing is normally executed (block 606). Next, the address trap generation circuit 440 generates a trap of the trap type “#10” expressing that an area has been accessed by a normal access request set in the corresponding trap type setting register 420 (block 608). The OS receives this trap and obtains an access log (block 610).

On the other hand, when the access address is an address in an inaccessible area, the address trap generation circuit 440 generates a trap of the trap type “#11”, set in the corresponding trap type setting register 420, expressing that an area has been accessed by an improper access request (block 612). The OS receives this trap, generates a memory image or a core file of the process or the application which issued the memory access, and forcibly ends the corresponding process (block 614).

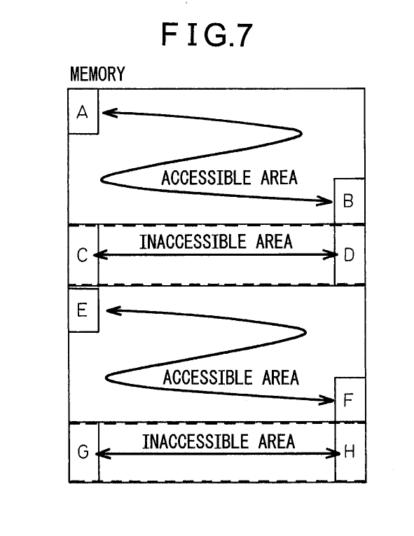

FIG. 7 is a view illustrating the setting of memory areas. In the example illustrated in FIG. 7, the memory area from the address “A” to the address “B” is an accessible area which is allocated to an application. Further, the memory area from the address “C” to the address “D” following the accessible area is an inaccessible area which is set corresponding to the accessible area. Similarly, the memory area from the address “E” to the address “F” is an accessible area, while the memory area from the address “G” to the address “H” is an inaccessible area.

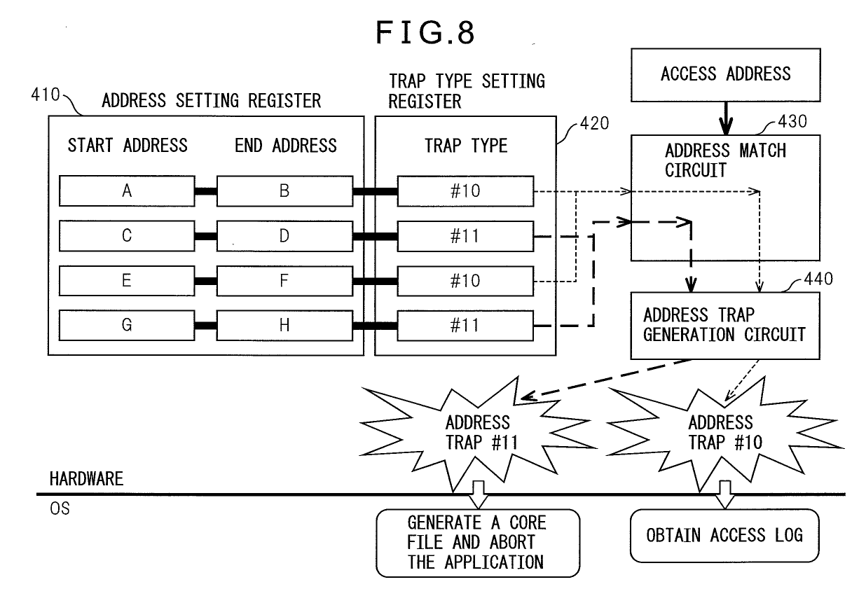

FIG. 8 is a view for explaining an operation corresponding to the setting of the memory areas illustrated in FIG. 7. Each address setting register 410 includes a start address register and an end address register. Corresponding to the setting of the memory areas illustrated in FIG. 7, the start address register of one address setting register 410 is set with the address “A”, while the end address register is set with the address “B”. Furthermore, the trap type setting register 420 corresponding to the address setting register 410 is set with the trap type “#10” provided for accessible area use expressing that the area was accessed by a normal access request.

The start address register of another address setting register 410 is set with the address “C” and its end address register is set with the address “D”. Furthermore, the trap type setting register 420 corresponding to the address setting register 410 is set with the trap type “#11” provided for inaccessible area use expressing that the area was accessed by an improper access request. The same is true for the accessible area from the addresses “E” to “F” and the inaccessible area from the addresses “G” to “H”.

Therefore, in the example illustrated in FIG. 7 and FIG. 8, when there is a normal access request to the memory area from the addresses “A” to “B” or the memory area from the addresses “E” to “F”, that is, accessible areas, a trap of the trap type “#10” is generated. Receiving that trap, the OS obtains a memory access log.

On the other hand, when there is an access request to a memory area from the addresses “C” to “D” or a memory area from the addresses “G” to “H”, that is, to an inaccessible area, a trap of the trap type “#11# indicating that an improper access request has been used for access is generated. Receiving this trap, the OS creates a memory image or a core file and causes the corresponding process or the application to abnormally end.

In this way, in the present embodiment, if the application accesses the memory area which is allocated from the OS, a corresponding trap is generated. The OS receives that trap and obtains an access log. On the other hand, if the application attempts to perform an invalid write operation exceeding the memory area which was allocated from the OS, a corresponding trap is generated. The OS receives that trap and immediately generates a memory image (core file) of the corresponding application to cause it to abnormally end. For this reason, it becomes possible to detect an invalid write operation early.

In the present disclosed art, it is possible to set a trap type reported by hardware in accordance with the application. A plurality of types of traps are prepared, so it is possible to change between obtaining an access log according to the area which the application accessed or generating a core file of a corresponding application and cause the application to end abnormally.

If an invalid write request is made from an application to an area other than the memory area acquired by the application, a core file of the application is immediately generated and the application is made to abnormally end. For this reason, it is possible to easily identify the process attempting the invalid write operation. Further, the trap mechanism of the data processing device is utilized to monitor memory access, so there is no need for debuggers and other software to be used to monitor all memory access. There is almost no deterioration of function due to this.

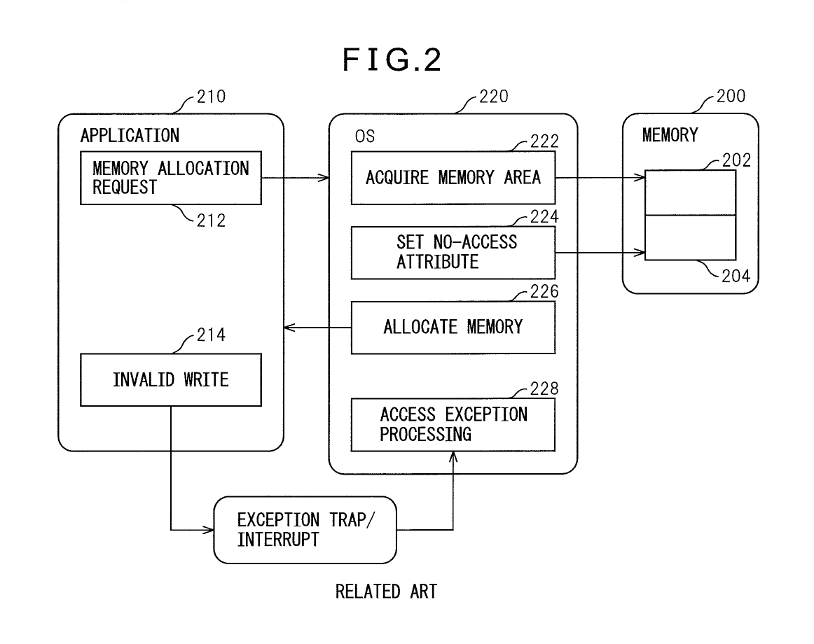

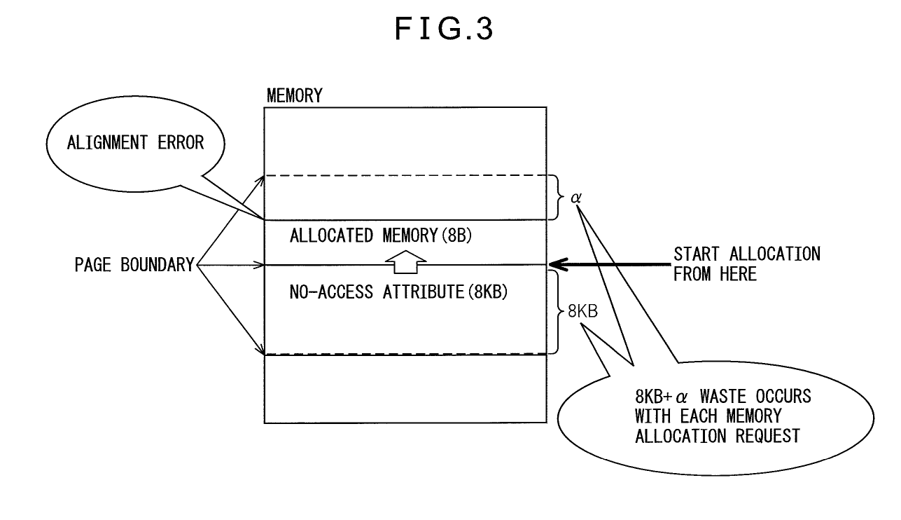

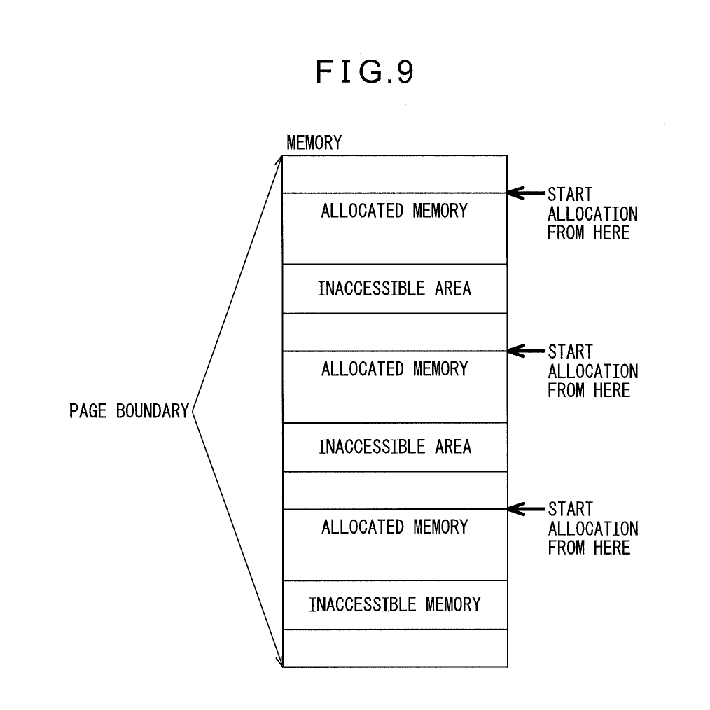

As explained above, in the related art illustrated in FIG. 2 and FIG. 3, each time an application issues a memory allocation request, one memory management unit of the OS's worth of unusable area (one page, for example, 1 page=8 kB) occurred. In the present disclosed art, it is possible to set the inaccessible area in any size without regard to the memory management unit of the OS, so it is not necessary to acquire extra memory. Further, as illustrated in FIG. 9, the data processing device of the disclosure can set multiple inaccessible areas in the same page.

Note that, in the present embodiment, each of the address setting registers 410 is configured to include a start address register in which a start address of a memory area is set and an end address register in which an end address of the memory area is set. Instead of this, it is also possible to have each of the address setting registers 410 configured to include a start address register in which a start address of a memory area is set and area size register in which a size of a memory area is set.

According to the embodiment, at the time of a memory allocation request from the application, an inaccessible area is set right after the memory area which has been allocated to the application, and that inaccessible area is set in an address setting register. If the application tries to access the inaccessible area, a trap will be generated at the data processing device. Due to this, when the application tries to perform an invalid write operation exceeding the size of the acquired memory area, a memory image or a core file of the corresponding application will be immediately generated and the corresponding application will be made to abnormally end. If analyzing the generated memory image of the application, the process which attempted the invalid write operation can be easily identified.

A user can set in advance the size of an inaccessible area for generating a trap, for when an application attempts an invalid write operation, to any size without regard to the memory management units of the OS. For this reason, a user can freely change the size of the inaccessible area in accordance with an envisioned size of memory destruction due to an invalid write operation. Further, there is no need for adjustment of alignment. As a result, effective use of memory resources is enabled while memory destruction due to an invalid write operation is prevented.

Although the embodiments of the present disclosed art have been described in detail, it should be understood that the various changes, substitutions, and alterations could be made hereto without departing from the spirit and scope of the disclosed art.

What is claimed is:

1. A data processing device comprising:
at least one address setting register that sets a memory area;
a trap type setting register that sets a trap type corresponding to the address setting register;
a trap generating unit that generates a trap of the trap type set in the trap type setting register in accordance with an access request to the memory area set at the address setting register;
an inaccessible area size setting unit that sets an inaccessible area size;
a memory allocating unit that allocates, in accordance with a memory allocation request from an application, a memory area to the application as an accessible area and an inaccessible area having the inaccessible area size right after the accessible area, and sets the inaccessible area in a first address setting register and a first trap type in a first trap type setting register; and
a memory access processing unit that generates a memory image of the application and closing the application when a trap of the first trap type is received from the trap generating unit.

2. The data processing device according to claim 1, further comprising:
an access log obtaining unit that obtains a log of memory access,
wherein the memory allocating unit, when allocating the memory area to the application as the accessible area, sets the accessible area in a second address setting register and a second trap type in a second trap type setting register, and the access log obtaining unit obtains a log of memory access when a trap of the second trap type is received from the trap generating unit.

3. The data processing device according to claim 1, wherein the address setting register includes a start address register to set a start address of the memory area and an end address register to set an end address of the memory area.

4. The data processing device according to claim 1, wherein the address setting register includes a start address register to set a start address of the memory area and an area size address register to set a size of the memory area.

5. A memory protection method executed by a data processing device, comprising:
setting a memory area in at least one address setting register;
setting a trap type in a trap type setting register corresponding to the address setting register;
generating a trap of the trap type set in the trap type setting register in accordance with an access request to the memory area set at the address setting register;
setting a size of an inaccessible area in a memory;
allocating, in accordance with a memory allocation request from an application, a memory area to the application as an accessible area and an inaccessible area having the inaccessible area size right after the accessible area;
setting the inaccessible area in a first address setting register and a first trap type in a first trap type setting register; and
generating a memory image of the application and closing the application when a trap of the first trap type is received.

6. The memory protection method according to claim 5, further comprising:
setting the accessible area in a second address setting register and a second trap type in a second trap type setting register; and
obtaining a log of memory access when a trap of the second trap type is received.

7. A non-transitory storage medium storing a program making a computer execute a procedure to protect a memory, the procedure comprising:
setting a memory area in at least one address setting register;
setting a trap type in a trap type setting register corresponding to the address setting register;
generating a trap of the trap type set in the trap type setting register in accordance with an access request to the memory area set at the address setting register;
setting a size of an inaccessible area in a memory;
allocating, in accordance with a memory allocation request from an application, a memory area to the application as an accessible area and an inaccessible area having the inaccessible area size right after the accessible area;
setting the inaccessible area in a first address setting register and a first trap type in a first trap type setting register; and
generating a memory image of the application and closing the application when a trap of the first trap type is received.

8. The non-transitory storage medium storing a program making a computer execute a procedure according to 7, the procedure further comprising:
setting the accessible area in a second address setting register and a second trap type in a second trap type setting register; and
obtaining a log of memory access when a trap of the second trap type is received.
